(19) United States
(12) Patent Application Publication
(10) Pub. No.: US 2011/0136960 A1
(43) Pub. Date: Jun. 9, 2011

(54) METHOD OF MAKING AN ATOMIZING AGENT

(75) Inventor: Chih-Hao Huang, Taipei (TW)

(73) Assignee: CHENG UEI PRECISION INDUSTRY CO., LTD., Taipei (TW)

(21) Appl. No.: 12/634,124

(22) Filed: Dec. 9, 2009

(51) Int. Cl. C08K 3/34; C08L 75/00

(52) U.S. Cl. 524/493; 524/589

(57) ABSTRACT

A method of making atomizing agent is described hereinafter. Firstly, make a nanometer silicon dioxide gel by means of a sol-gel method. Next, mix a proper quantity of nanometer silicon dioxide gel and organic solvent together to form a nanometer silicon dioxide solution. Lastly, add a proper quantity of water-based polyurethane resin or de-ionized water into the nanometer silicon dioxide solution so as to obtain the atomizing agent by means of being stirred for 1 hour and then aging for 24 hours under a room temperature.

### BACKGROUND OF THE INVENTION

1. Field of the Invention

The present invention generally relates to a chemical agent, and more particularly to a method of making an atomizing agent.

2. The Related Art

At present, lots of products are made of engineering plastic materials. There are different types of surface treatment technologies that are used in order to enhance the surfaces of the plastic products. Here are two methods for producing the plastic product with atomized surfaces. One conventional method is executed by means of regulating process temperature and molds during molding the plastic product to form the atomized surfaces on the plastic product. However, it results in a complicated process and a low productivity. Another conventional method is executed by means of incorporating atomizing agents into the plastic materials in the manufacturing processes to finally achieve the plastic product with the atomized surfaces, wherein the atomizing agent is mainly made of silica powder having a 5˜15 um diameter. However, a greater quantity of atomizing agents is embedded in the plastic product without any effects, thus resulting in materials waste and increasing manufacture cost. Furthermore, an excess of silica powder in the atomizing agent will cause the difficulty of forming the atomized surfaces on the plastic product, and the atomized surfaces formed by the atomizing agent further has a high surface glossiness.

### SUMMARY OF THE INVENTION

An object of the present invention is to provide a method of making atomizing agent. The method is described hereinafter. Firstly, make a nanometer silicon dioxide gel by means of a sol-gel method. Next, mix a proper quantity of nanometer silicon dioxide gel and organic solvent together to form a nanometer silicon dioxide solution. Lastly, add a proper quantity of water-based polyurethane resin or de-ionized water into the nanometer silicon dioxide solution so as to obtain the atomizing agent by means of being stirred for 1 hour and then aging for 24 hours under a room temperature.

As described above, the above-mentioned method according to the present invention can make an atomizing agent which can well atomize a surface of a substrate to form an atomized film with a lower surface glossiness. Therefore, it can achieve a simple process, a high productivity and a low manufacture cost.

### DETAILED DESCRIPTION OF THE PREFERRED EMBODIMENT

A method of making an atomizing agent according to the present invention is described hereinafter.

Firstly, a nanometer silicon dioxide gel with an about 8-10 nm diameter is made by means of a sol-gel method.

Next, a proper quantity of nanometer silicon dioxide gel and organic solvent are mixed together to form a nanometer silicon dioxide solution, wherein the weight ratio of the nanometer silicon dioxide gel to the organic solvent is 1:1, and the organic solvent may be any one of or a mixture of an ethanol solvent and an isopropanol solvent.

Lastly, under a room temperature, add a proper quantity of water-based polyurethane resin or de-ionized water into the nanometer silicon dioxide solution so as to obtain the atomizing agent by means of being stirred for 1 hour and then aging for 24 hours, wherein the weight ratio of the polyurethane resin in the water-based polyurethane resin to the nanometer silicon dioxide solution is 5-25:100, the weight ratio of the de-ionized water to the nanometer silicon dioxide solution is 5-32.5:100, and the polyurethane resin in the water-based polyurethane resin has a 10% concentration.

A method of atomizing a surface of a substrate with the foregoing atomizing agent is described hereinafter. Firstly, the atomizing agent is coated onto the surface of the substrate evenly by way of spraying, dipping or roll-to-rolling. Then the substrate coated with the atomizing agent is subjected to a heating environment of 50-100 degrees centigrade for 10-30 minutes so as to form an atomized film on the surface of the substrate.

One unlimited embodiment is introduced for describing the above-mentioned method of making the atomizing agent in detail. In the unlimited embodiment, 10% concentration of water-based polyurethane resin is added into the nanometer silicon dioxide solution so as to obtain the atomizing agent by means of being stirred for 1 hour and then aging for 24 hours under a room temperature, wherein the weight ratio of the polyurethane resin in the water-based polyurethane resin to the nanometer silicon dioxide solution is 1:10, namely slowly adding 1000 g 10% concentration of water-based polyurethane resin into 1000 g nanometer silicon dioxide solution during stirring the nanometer silicon dioxide solution. Then the substrate is processed by the above-mentioned method for forming the atomized film on the surface thereof, wherein the substrate is made of plastic materials. Next, do a surface glossiness test to the atomized film of the substrate based on a gloss meter with a 60° measuring angle. As a result, the measured value is equal to 9.3. However, the surface glossiness of an atomized surface of a plastic product in the prior art is measured by the gloss meter with the 60° measuring angle to equal 13.3.

Another unlimited embodiment is introduced for describing the above-mentioned method of making the atomizing agent in detail again. In the unlimited embodiment, a proper quantity of de-ionized water is added into the nanometer silicon dioxide solution so as to obtain the atomizing agent by means of being stirred for 1 hour and then aging for 24 hours under a room temperature, wherein the weight ratio of the de-ionized water to the nanometer silicon dioxide solution is 1:10, namely slowly adding 100 g de-ionized water into 1000 g nanometer silicon dioxide solution during stirring the nanometer silicon dioxide solution. Then the substrate is processed by the above-mentioned method for forming the atomized film on the surface thereof, wherein the substrate is made of plastic materials. Next, do a surface glossiness test to the atomized film of the substrate based on a gloss meter with a 60° measuring angle. As a result, the measured value is equal to 10.1. However, the surface glossiness of the atomized surface of the plastic product in the prior art is measured by the gloss meter with the 60° measuring angle to equal 13.3.

As described above, the atomizing agent made by the above-mentioned method of the present invention can well atomize the surface of the substrate to form the atomized film with a lower surface glossiness. Therefore, it can achieve a simple process, a high productivity and a low manufacture cost.

What is claimed is:

1. A method of making atomizing agent, comprising the steps of:
making a nanometer silicon dioxide gel by means of a sol-gel method;
mixing the nanometer silicon dioxide gel and the organic solvent together to form a nanometer silicon dioxide solution; and
adding water-based polyurethane resin or de-ionized water into the nanometer silicon dioxide solution so as to obtain the atomizing agent by means of being stirred for 1 hour and then aging for 24 hours under a room temperature.

2. The method as claimed in claim 1, wherein a particle diameter of the nanometer silicon dioxide gel is 8-10 nm.

3. The method as claimed in claim 1, wherein the weight ratio of the nanometer silicon dioxide gel to the organic solvent is 1:1.

4. The method as claimed in claim 1, wherein the organic solvent is any one of or a mixture of an ethanol solvent and an isopropanol solvent.

5. The method as claimed in claim 1, wherein the weight ratio of polyurethane resin in the water-based polyurethane resin to the nanometer silicon dioxide solution is 5-25:100.

6. The method as claimed in claim 5, wherein the polyurethane resin in the water-based polyurethane resin has a 10% concentration.

7. The method as claimed in claim 1, wherein the weight ratio of the de-ionized water to the nanometer silicon dioxide solution is 5-32.5:100.
